(19) United States
(12) Patent Application Publication
(10) Pub. No.: US 2007/0262169 A1
(43) Pub. Date: Nov. 15, 2007

(54) Spray head structure of a spray gun

(75) Inventor: Beason Wang, Hsin Chuang City (TW)

Correspondence Address: BIRCH STEWART KOLASCH & BIRCH, PO BOX 747, FALLS CHURCH, VA, 22040-0747, US

(73) Assignee: CHIA CHUNG PRECISION INDUSTRIAL CO., LTD.

(21) Appl. No.: 11/414,291

(22) Filed: May 1, 2006

(51) Int. Cl. B05B 1/28; B05B 1/00

(52) U.S. Cl. 239/290; 239/291; 239/600

(57) ABSTRACT

A spray head structure of a spray gun includes a shunt ring, and two end surfaces of which are extended outward with positioning pillars corresponding to position holes of a fixing seat and the spray gun, respectively. An end surface of the shunt ring, facing to the spray gun, is provided with a shunt sink and an outer gas hole, and the fixing seat is provided with a connection hole and a cover ring. Gas inside the spray gun can be shunted to an interior of spray head and pressure of the gas can be stabilized, by locking a nozzle with the shunt ring and the fixing seat.

### BACKGROUND OF THE INVENTION

a) Field of the Invention

The present invention relates to a spray head structure of a spray gun, and more particularly to a spray head structure wherein gas inside the spray gun is shunted without interfering with each other, and pressure of the gas after being shunted can be stabilized.

b) Description of the Prior Art

All of spray head products on the general market are designed to be more sophisticated to be in compliance with all kinds of various requirements. In addition, in considering a requirement of a stable and uniform exit flow of gas, a pressure stabilizing structure is usually installed in a passage through which a high pressure gas will pass, in order to mitigate a direct escape of the high pressure gas from a nozzle during a process of discharging, thereby affecting a performance of spraying operation. Referring to FIG. 1 and FIG. 2, in a Taiwan New Utility Patent 510253, “Spray Head Structure in which a Nozzle is Replaceable,” a sealing disc b, a connection seat c, a nozzle d, a spray head d, and a screw nut f are orderly assembled at a front end of spray gun a, wherein a front section of passage of an adjusting pin a1, extended from a center of surface of gas exit end at a head part of spray gun a, forms a screw hole for connecting to the connection seat c; the sealing disc b is installed between the end surface and the connection seat c; mutually corresponding inner and outer groove rings a2, a3, c1, c2 are formed on the end surface and a surface of the connection seat c which is facing to the end surface, respectively; the sealing disc b is correspondingly formed with a ring of slot holes b1; interiors of the inner and outer groove rings a2, a3 of the spray gun a are provided with an gas exit duct a4, respectively; an interior of the outer groove ring c2 of connection seat c is provided with a plurality of gas exit holes c21 which are transfixed to a groove space at a front end surface and segmented by a flange ring c22; a groove ring c4 is formed at a circumference of a hollow screw tube c3 at a front side of the connection seat c using an outer rim as a push surface c41, and a gas hole c11 in an interior of the inner groove ring c1 is embedded into a wall of the groove ring c4 for connection. On the other hand, the nozzle d is screwed at a front end of the connection seat c, its outer rim is formed with a disc d1 which is extended to an inner rim of the ring groove c4, and an interior of the spray head e is provided with a circular indentation e1 for holding the nozzle d. A circumference of end rim of the circular indentation e1 is formed with a push ring e11 which can be connected to the push surface c41 of groove ring c4 of connection seat c. The disc d1 is used to block a gas flowing from the gas hole c11 of inner groove ring c1 of connection seat c, the flange ring c22 is used to block a gas flowing from the gas exit holes c21 of outer groove ring c2 of connection seat c, and then the high pressure gas is discharged from gaps formed between the disc d1 and an inner ring wall of the spray head e, and between the flange ring c22 and an inner ring wall of the screw nut f, thereby achieving an effect of stabilizing the pressure. However, the aforementioned spray head structure is not provided with a shunt structure; therefore it is not suitable for a kind of spray gun which is only provided with a single inner, outer gas exit ducts, and wherein the inner, outer gas exit ducts are not installed with an inner, outer groove ring.

Accordingly, to be in cooperation with an application to the aforementioned spray gun having the single inner, outer gas exit ducts, a brand new spray head structure of a spray gun is invented, which uses a special design of a shunt ring and a fixing seat to shunt the inner and outer gas exit ducts to inner and outer ducts formed in an interior of the spray head structure, and is also provided with an effect of stabilizing the pressure of gas flowing in the inner and outer ducts.

### SUMMARY OF THE INVENTION

The primary object of present invention is to provide an improved structure of spray head which can uniformly shunt gas inside a spray gun to inner and outer ducts of spray head, and can also stabilize pressure of gas flowing in the inner and outer ducts.

Accordingly, the spray head structure of a spray gun of present invention comprises primarily a shunt ring, a fixing seat, a nozzle, a cap, and a screw nut which are orderly assembled at a front end of spray gun to be used for a spraying operation, wherein the spray gun is only provided with a single inner and outer gas exit ducts, two end surfaces of the shunt ring are extended outward with positioning pillars corresponding to positioning holes of the fixing seat and the spray gun respectively, and proper positions on an end surface of the shunt ring, facing to the spray gun, are provided with a shunt sink and an outer gas hole respectively, with the shunt sink being corresponding to the inner gas exit duct of spray gun, and the outer gas hole being corresponding to the outer gas exit duct. An inner wall of the fixing seat is provided with an overlapped annulus member, and a cover ring which is used for stabilizing pressure. A proper position of the annulus is provided with a connection hole to be connected with the outer gas hole. After a screw tube of nozzle is screwed into a thread part inside the spray gun, a cone surface of a ring member can be locked with the shunt ring and the fixing seat, and the ring member is concentrically installed with a plurality of gas holes. The other end surface of ring member is provided with a top cone surface for being tightly connected with a top cone of hollow tube of cap, and the top cone is formed inward with a flange ring to serve as another pressure stabilizing structure.

According to the aforementioned structures, after the shunt sink is connected with the inner gas exit duct, and the outer gas hole is connected with the outer gas exit duct, the shunt sink can distribute equally the gas discharged from the inner gas exit duct into each gas hole of nozzle, and the gas discharged from the outer gas exit duct will flow through the outer gas hole and the connection hole of fixing seat to reach into the outer duct of cap, thereby achieving an effect of shunting the gas to the inner and outer ducts of spray head. By a pressure stabilizing structure formed by the cover ring of fixing seat and an outer wall of the screw tube of nozzle, and a pressure stabilizing structure formed by the flange ring of cap and an outer wall of a tip tube of nozzle, the pressure of gas flowing in the inner and outer ducts can be stabilized.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an exploded view of a conventional spray head structure.

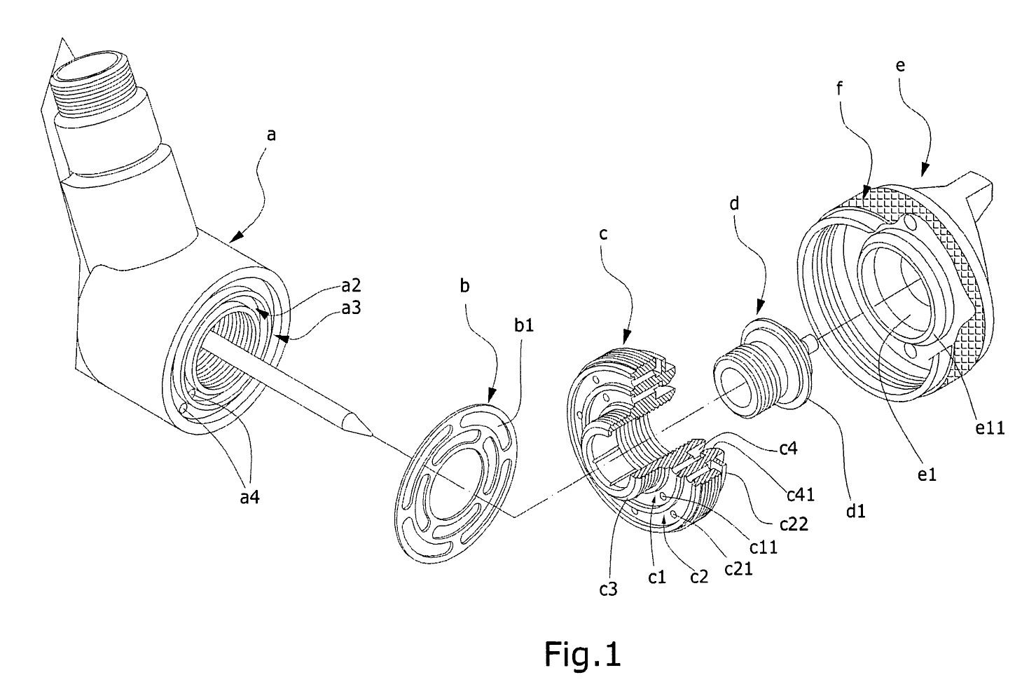

FIG. 2 shows a cutaway view of a conventional spray head structure after being assembled.

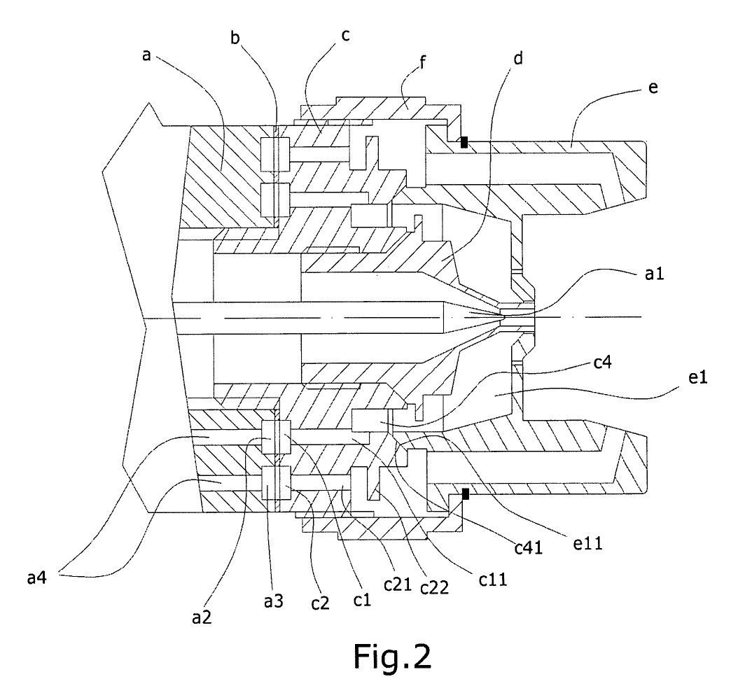

FIG. 3 shows an exploded view of the present invention.

FIG. 4 shows a cutaway view of the present invention after being assembled.

FIG. 5 shows a schematic view of a gas flow upon using the present invention.

### DETAILED DESCRIPTION OF THE PREFERRED EMBODIMENTS

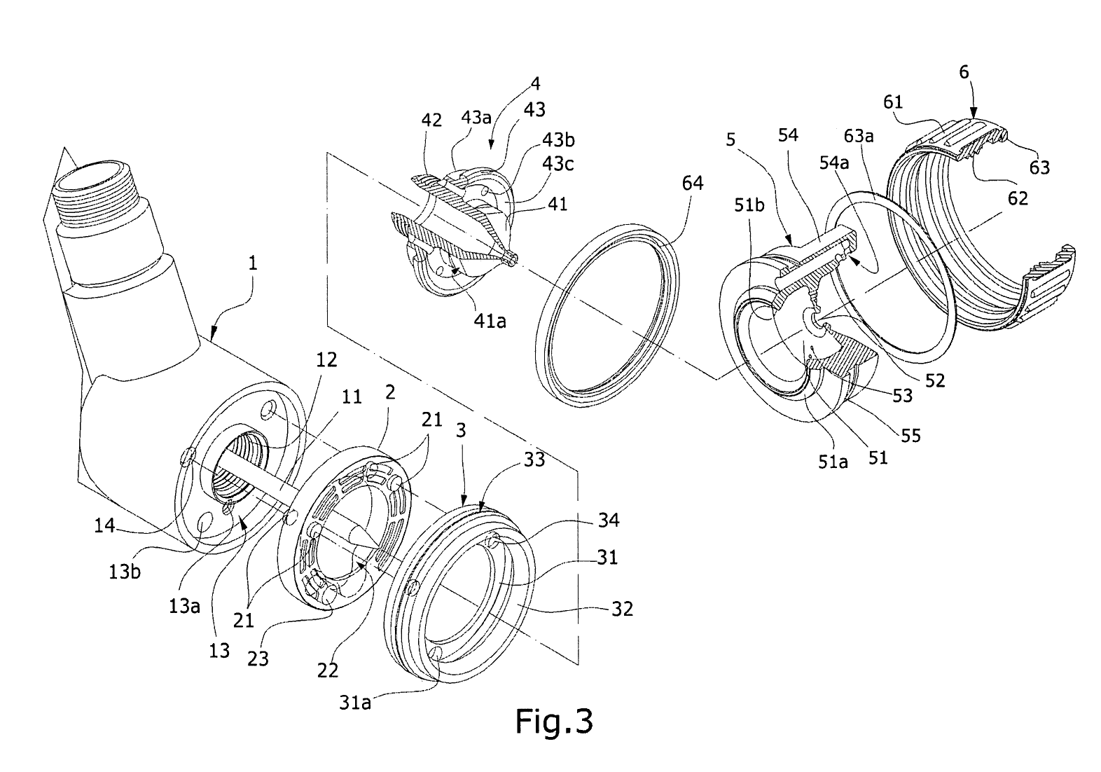

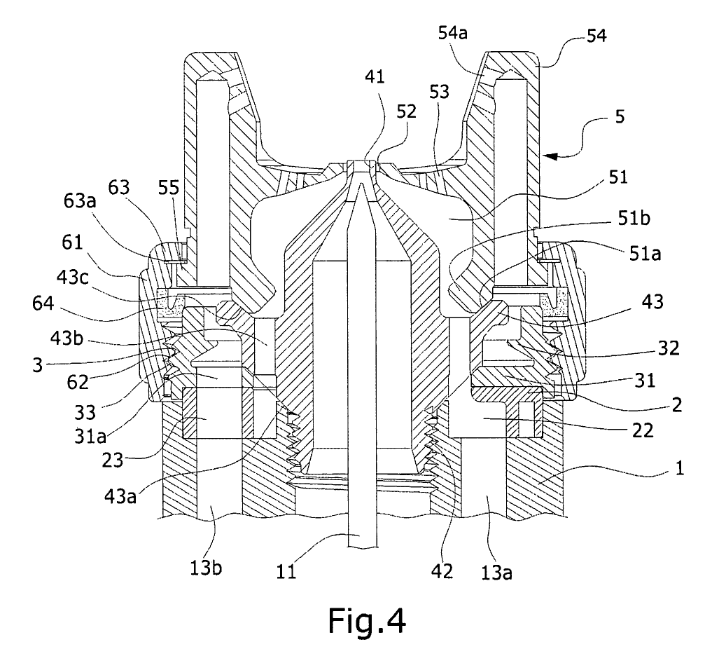

Referring to FIG. 3 and FIG. 4, in a spray head structure of a spray gun of the present invention, a shunt ring 2, a fixing seat 3, a nozzle 4, a cap 5, and a screw nut 6 are orderly assembled at a front end of spray gun 1.

An adjusting pin 11 is extended from a center of front end part of the spray gun 1, and an inner wall of passage that the adjusting pin 11 passes through is provided with a thread part 12 for screwing with the fixing seat 3. An end surface on an exterior side of the passage is formed with a groove ring 13, and a proper position of end surface on the groove ring 13 is located with an inner gas exit duct 13a, an outer gas exit duct 13b, and two positioning holes 14 which are corresponding to positioning pillars 21 of the shunt ring 2.

Two end surfaces of the shunt ring 2 are extended outward with a plurality of positioning pillars 21 respectively, and proper positions on the end surface of shunt ring 2, facing to the spray gun 1, are separately installed with a shunt sink 22 and an outer gas hole 23, with the shunt sink 22 being protruded and corresponding to the inner gas exit duct 13a of spray gun 1, and the outer gas hole 23 being corresponding to the outer gas exit duct 13b of spray gun 1.

The fixing seat 3 is made into a tube, its inner wall is circumferentially installed with an overlapped annulus member 31 and a cover ring 32 for stabilizing pressure, a proper position on the annulus member 31 is provided with a connection hole 31a to be connected to the outer gas hole 23 of shunt ring 2, an outer wall of the fixing seat 3 is provided with a thread part 33 for screwing with the screw nut 6, and an end surface facing to the shunt ring 2 is installed with positioning holes 34 corresponding to the positioning pillars 21.

An end of the nozzle 4 is a tip tube 41, whereas the other end is a screw tube 42. The screw tube 42 is to be screwed into the thread part 12 inside the spray gun 1, an outward extended ring member 43 is formed between the tip tube 41 and the screw tube 42, and an end surface of the ring member 43, facing to the spray gun 1, is formed with a cone surface 43a. When the ring member 43 is screwed in an interior of the spray gun 1, it will be locked at the positions of shunt ring 2 and fixing seat 3 with the cone surface 43a. The ring member 43 is concentrically installed with a plurality of gas holes 43b, and the other end surface of ring member 43 is provided with a top cone surface 43c to be tightly connected with the cap 5. In addition, a circumference of the tip tube 41 is provided with a hexagonal sleeve 41a to be in cooperation with a tool for screwing the nozzle 4.

A center of the cap 5 is a hollow tube 51 which is made after cutting and processing a semi-sphere protruded on a bottom surface of the nozzle 4, an outer circumference at an opening of the hollow tube 51, corresponding to a top cone surface 43c, is provided with a top cone 51a. Therefore, the top cone 51a is in a curved surface in a cutaway view, and is integrally formed with a flange ring 51b toward an inner rim of opening of hollow tube 51; whereas a top surface of the hollow tube 51 is provided with a spray hole 52 into which the tip tube 42 can be transfixed. A plurality of turbo-holes 53 is located on a concentric ring at a periphery of the spray hole 52, an gas exit seat 54 is protruded at two sides of the other surface, a top end of the gas exit seat 54 is formed inward with a gas exit hole 54a, and an outer wall is provided with a flange ring 55 for locking the screw nut 6.

An outer wall of the screw nut 6 is provided with a knurl part 61, an inner wall is provided with a thread part 62 for screwing with the fixing seat 3, and an opening at the other end is formed inward with a lock ring 63 which can be latched with the flange ring 55 of cap 5, whereas an interior of the lock ring 63 is provided with a leak-proof piece 63a. In addition, a leak-proof rubber ring 64 is located on an outer wall in an interior of the screw nut 6, at a proper position corresponding to the fixing seat 3.

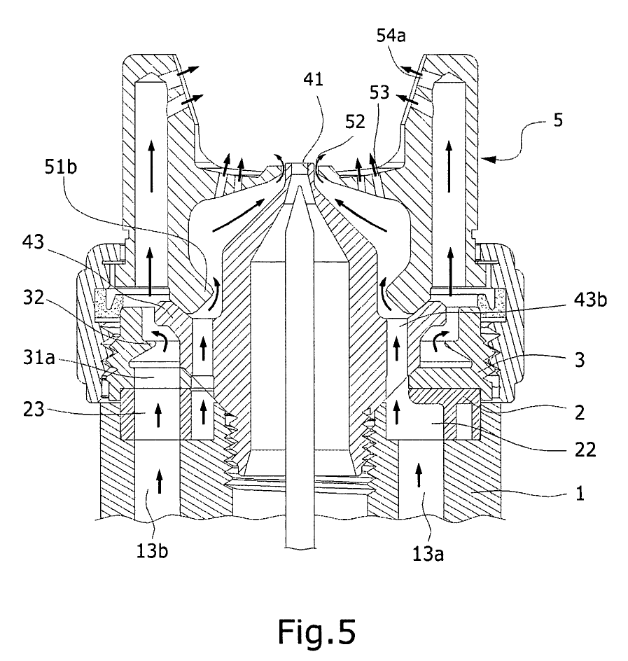

Referring to FIG. 5, after gas is discharged from the inner gas exit duct 13a and the outer gas exit duct 14a, the shunt sink 22 will distribute equally the gas discharged from the inner gas exit duct 13a into each gas hole 43b of nozzle 4, and the gas discharged from the outer gas exit duct 13b will flow through the outer gas hole 23 and the connection hole 31a of fixing seat 3 to reach into the outer duct of cap 5. In addition, a pressure stabilizing structure of outer duct is formed by the cover ring 32 of fixing seat 3 and an outer wall of ring member 43 of nozzle 4, whereas a pressure stabilizing structure of inner duct is formed by the flange ring 51b of cap 5 and an outer wall of tip tube 41 of nozzle 4, such that the gas will be discharged after being accumulated, thereby achieving an effect of stabilizing the gas pressure. Finally, the gas will be expelled out from the spray hole 52, the turbo-holes 53, and the gas exit hole 54a of cap 5.

Accordingly, the spray head structure of spray gun of present invention uses the shunt ring to connect with the fixing seat, so as to shunt the gas sent out from the spray gun, and is also provided with the effect of stabilizing the pressure of gas flowing in the inner and outer ducts.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A spray head structure of a spray gun comprising a shunt ring, a fixing seat, a nozzle, a cap, and a screw nut which are orderly assembled at a front end of spray gun to be used for a spraying operation, wherein the spray gun is only provided with a single inner, outer gas exit ducts; two end surfaces of shunt ring are extended outward with positioning pillars corresponding to positioning holes of the fixing seat and the spray gun respectively; and proper positions of an end surface of the shunt ring, facing to the spray gun, are respectively formed with an shunt sink and an outer gas hole, with the shunt ring being corresponding to the inner gas exit duct of spray gun, and the outer gas hole being corresponding to the outer gas exit duct; an inner wall of fixing seat being provided with an overlapped annulus member and a cover ring which is used to stabilize pressure, and a proper position on the annulus member being provided with a connection hole to be connected with the outer gas hole; after a screw tube of nozzle being screwed into a thread part inside the spray gun, a cone surface of a ring member being able to be locked with the shunt ring and the fixing seat, and the ring member being concentrically provided with a plurality of gas holes; the other end surface of ring member being provided with a top cone surface to be tightly connected with a top cone of hollow tube of cap; the top cone being made by cutting and processing a semi-sphere protruded on a bottom surface of the nozzle, being in a curved shape in a cutaway view, and being formed inward with a flange ring to serve as another pressure stabilizing structure.

2. The spray head structure of a spray gun according to claim 1, wherein a circumference of the tip tube at one end of the nozzle is provided with a hexagonal sleeve to be in cooperation with a tool for screwing the nozzle.
